(19) United States
(12) Patent Application Publication
(10) Pub. No.: US 2022/0331632 A1
(43) Pub. Date: Oct. 20, 2022

(54) SYSTEMS AND METHODS OF FIRE PROTECTION SPRINKLERS

(71) Applicant: Tyco Fire Products LP, Lansdale, PA (US)

(72) Inventors: Carson Anders Coelho, Mattapoisett, MA (US); Manuel R. Silva, JR., Cranston, RI (US); Sean E. Cutting, West Warwick, RI (US); Jeremy Tyler Cogswell, Johnston, RI (US)

(73) Assignee: Tyco Fire Products LP, Lansdale, PA (US)

(21) Appl. No.: 17/693,654

(22) Filed: Mar. 14, 2022

Related U.S. Application Data
(60) Provisional application No. 63/174,190, filed on Apr. 13, 2021.

(51) Int. Cl. A62C 35/68; A62C 35/64; A62C 31/02

(52) U.S. Cl. CPC A62C 35/68; A62C 35/64; A62C 31/02

(57) ABSTRACT

A sprinkler includes a body defining a bore extending from an inlet to an outlet. At least one of an inner diameter and a wall thickness of the bore can be sized such that a K-factor of the sprinkler is within a threshold of 30.8, the K-factor defined in units of gallons per minute [gpm]/(pounds per square inch [psi])^{1/2}.

### CROSS-REFERENCE TO RELATED APPLICATIONS

The present application claims the benefit of and priority to U.S. Provisional Application No. 63/174,190, filed Apr. 13, 2021, the disclosure of which is incorporated herein by reference in its entirety.

### BACKGROUND

Sprinkler systems can be provided in buildings to address fire conditions. Sprinkler systems can include fire protection sprinklers that connect with piping systems to receive fluid to address the fire conditions.

### SUMMARY

At least one aspect relates to a sprinkler. The sprinkler can include a body defining a bore extending from an inlet to an outlet. At least one of an inner diameter and a wall thickness of the bore can be sized such that a K-factor of the sprinkler is within a threshold of 30.8, the K-factor defined in units of gallons per minute [gpm]/(pounds per square inch [psi])^{1/2}.

At least one aspect relates to a sprinkler system. The sprinkler system can include one or more pipes coupled with a fluid supply providing fluid at a pressure greater than or equal to 5 psi and less than or equal to 200 psi, and a sprinkler. The sprinkler can include a bore extending from an inlet coupled with the one or more pipes to an outlet. The bore can be sized such that a K-factor of the sprinkler is within a threshold of 30.8, the K-factor defined in units of gallons per minute [gpm]/(pounds per square inch [psi])^{1/2}.

At least one aspect relates to a sprinkler. The sprinkler can include a body defining a bore extending between an inlet and an outlet. The bore can be shaped so that a nominal K-factor of the sprinkler is 30.8. The sprinkler can include a seal positioned in the outlet, at least one frame arm extending from the body, a deflector coupled with the at least one frame arm, and a thermal activation element between the seal and the deflector.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts a block diagram of an example of a sprinkler system.

FIG. 2 depicts a side view of an example of a sprinkler.

FIG. 3 depicts a cross-section view of an example of a sprinkler having a straight bore.

FIG. 4 depicts a cross-section view of an example of a sprinkler having a bore including a stepped portion.

FIG. 5 depicts a cross-section view of an example of a sprinkler having a bore including a tapered portion.

FIG. 6 depicts a cross-section view of an example of a sprinkler having a radiused inlet.

FIG. 7 depicts a cross-section of an example of a sprinkler having a chamfered inlet.

FIG. 8 depicts an end view of examples of outlets of a sprinkler.

### DETAILED DESCRIPTION

The present disclosure generally relates to fire sprinkler systems. More particularly, the present disclosure relates to sprinkler that can have a nominal K-factor of 30.8 [gpm]/[psi]^{1/2}, and which can have at least one of decreased system pressure requirements and decreased piping diameter requirements.

Sprinkler systems include sprinklers that can inhibit or permit flow of fluid (water or other fire suppressant fluid). In the instance of a fire or detected conditions that may be indicative of a fire (e.g., increased heat, smoke, etc.), the sprinklers can permit the flow of fluid such that the fluid may contact a deflector and be dispersed so as to address the fire. The sprinklers may disperse water or fire protection fluid over a specific area, for example a storage commodity, a portion of a room or hallway, or a window or wall. In order to accomplish fire exposure protection for a given area (e.g., room, hallway, window, wall, etc.), sprinklers couple with a piping system that directs fire suppressant from a source to the sprinklers. The sprinklers can selectively couple with the piping during installation of the fire suppression system. For example, sprinklers include threading that can interface with threading on the piping system to fluidly seal the sprinklers to the piping system.

Although sprinklers have been manufactured having nominal K-factors of 28.0 and 33.6, such as the VK514 manufactured by Viking Corporation or the TYCO Model ESFR-34 manufactured by Tyco Fire Products, considerations such as wall thickness of the body of the sprinkler have made it difficult to manufacture a sprinkler that can achieve flow rates corresponding to a nominal K-factor of 30.8 over a target range of fluid pressures (e.g., a range of pressures used by a testing agency to validate use of the sprinklers, such as Underwriters Laboratories or FM Global, such as a range of about 7 psi to 175 psi or any of a variety of ranges within 7 psi to 175 psi), including for nominal pipe connection sizes of 1 inch.

Sprinkler systems in accordance with the present disclosure can include a sprinkler that has a geometry allowing the sprinkler to achieve a nominal K-factor of 30.8. For example, the sprinkler can have a bore extending along a longitudinal axis from an inlet that connects with one or more pipes or pipe fittings to receive fluid from a fluid supply to an outlet. The bore can include at least one of a straight portion, a step, and a tapered portion, which can facilitate reducing friction losses through the bore, improving flow rates of fluid outputted from the sprinkler.

The sprinkler can be sized to connect with a 1 inch national pipe tapered thread (NPT) fitting or an ISO-7-R1 fitting while providing flow rates of fluid output from the outlet that might otherwise require 1.25 inch or greater diameter piping outlets or connections. The sprinkler can include outlets of various geometries, such as circular, oval, rectangular, and square geometries. The inlet can include radiused or chamfered portions, which can reduce friction losses at a transition from a pipe or fitting into the sprinkler and thus improve flow rates of fluid outputted from the sprinkler.

The sprinkler and various other components of the system can be used for storage applications, including but not limited to use for ceiling-only systems, and for ceiling heights up to and over fifty five feet, including ceiling heights greater than or equal to forty feet and less than or equal to fifty feet. For example, the system can be used for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof. The system can be used in accordance with various standards, such as standards set forth by the National Fire Protection Association (NFPA) or FM Global.

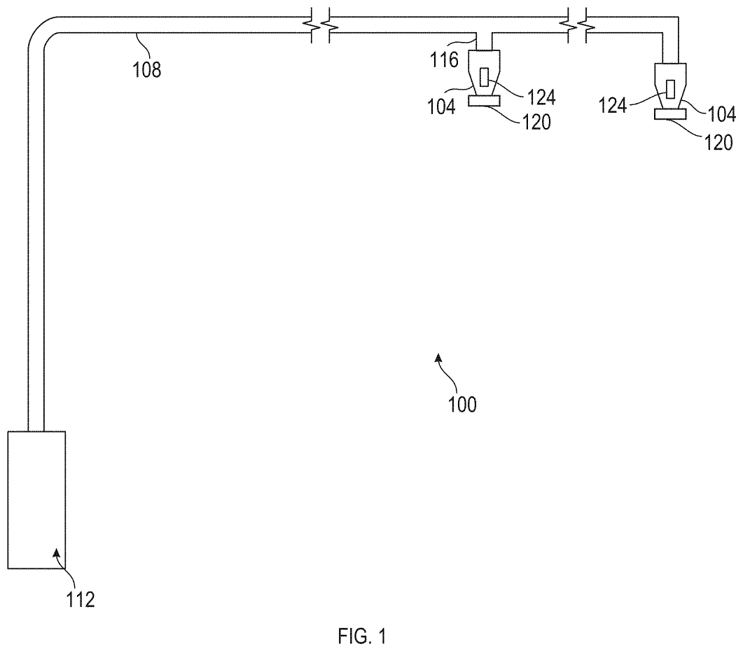

FIG. 1 depicts a fire suppression system 100. The fire suppression system 100 can be a chemical fire suppression system. The fire suppression system 100 can distribute a fire suppressant agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building).

The fire suppression system 100 can be used in a variety of applications. The fire suppression system 100 can be used with a variety of fire suppressant agents, including but not limited to water (e.g., may use powders, liquids, foams, or other fluid or flowable materials). The fire suppression system 100 can be used for storage applications, including ceiling-only, in-rack, or a combination of ceiling and rack sprinklers, such as to be installed for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof.

The fire suppression system 100 can include or be coupled with a fluid supply 112. The fluid supply 112 can define an internal volume filled (e.g., partially filled, completely filled) with fire suppressant agent. The fluid supply 112 can provide fluid from a remote or local location to a building in which the fire suppression system 100 is located. The fluid supply may include, for example, a municipal water supply, pump, piping system, tank, cylinder, or any other source of water or fire suppression agent.

Piping 108 (e.g., one or more pipes, tubes, conduits, or fittings) can be fluidly coupled with one or more sprinklers 104. The piping 108 can include vertical pipes 116. The vertical pipes 116 can extend perpendicular from the piping 108. The sprinklers 104 can receive water or other fire suppressant agent from the fluid supply 112 via the piping 108 and the vertical pipes 116. Due to the reduced pressures that can be achieved through the sprinklers 104 while still achieving target outputs of fluid, at least some of the piping 108 can have connections or outlets with relatively lesser diameters, such as 1 inch NPT or ISO-7-R1 connections or outlets.

The sprinklers 104 can each define one or more outlets, through which the fire suppressant agent exits and contacts a deflector 120, such as to form a spray of water or other fire suppressant agent that covers a desired area. The sprays from the sprinklers 104 then suppress or extinguish fire within that area. The deflectors 120 of the sprinklers 104 can be shaped to control the spray pattern of the fire suppressant agent leaving the sprinklers 104. The sprinklers 104 can be used as concealed sprinklers, pendent sprinklers, upright sprinklers, water mist nozzles, or any other device for spraying fire suppressant agent.

The sprinklers 104 can include an activation element (e.g., thermal element) 124. The activation element 124 can change from a first state that prevents fluid flow out of the sprinkler 104 to a second state that permits fluid flow of the sprinkler 104 responsive to a fire condition. For example, the activation element 124 can include a glass bulb including a fluid that expands responsive to an increase in temperature (e.g., responsive to heat provided to the fluid from a fire), such as to cause the glass bulb to break responsive to the temperature meeting or exceeding a threshold temperature; the activation element 124 can include a fusible link that includes two or more pieces coupled using a solder than can melt responsive to the temperature meeting or exceeding a threshold temperature; the activation element 124 can include an electric actuator (e.g., an electrically triggered pyrotechnic actuator or electrically actuated bulb or link). The activation element 124 can have a response time index (RTI) less than or equal to 80 (m/s)^{1/2}, or less than or equal to 50 (m/s)^{1/2}.

The sprinklers 104 can be early suppression, fast response (ESFR) sprinklers. The sprinklers 104 can be arranged (e.g., in a grid or tree arrangement over a storage commodity) to have sprinkler to sprinkler spacings greater than or equal to eight feet by eight feet and less than or equal to twelve feet by twelve feet.

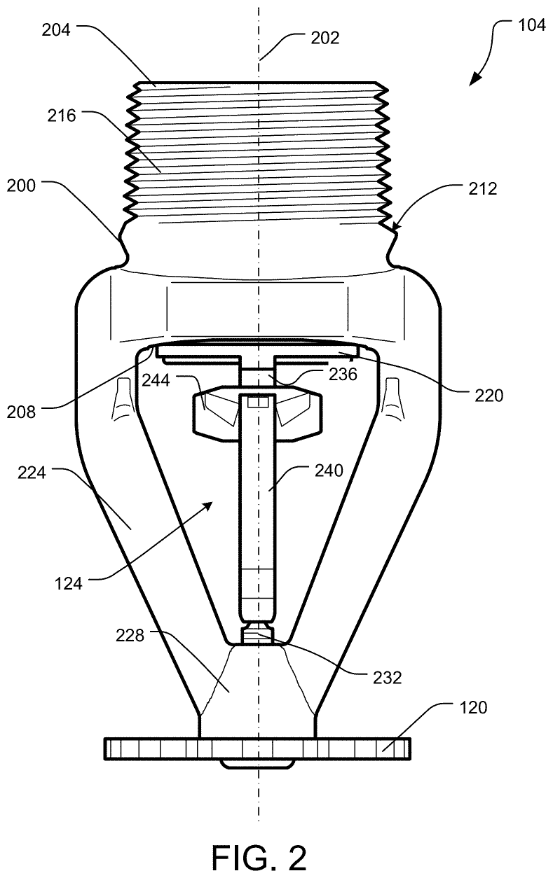

FIG. 2 depicts an example of the sprinkler 104 in a pendent orientation. The sprinkler 104 includes a body 200 extending along a longitudinal axis 202 from an inlet 204 to an outlet 208. The inlet 204 can connect with the piping 108 (e.g., directly or using a fitting). The inlet 204 can be sized to connect with 1 inch NPT or ISO-7-R1 outlets or connections of the piping 108.

The body 200 can include an outer surface 212 having an engagement member 216. The engagement member 216 can be a threaded member, such as NPT thread for connecting with 1 inch NPT or ISO-7-R1 components.

The sprinkler 104 can include a seal 220 that can be positioned in the outlet 208 to seal the outlet 208. For example, the seal 220 can be a sprinkler button. The seal 220 can be held in the outlet 208 by the activation element 124.

As depicted in FIG. 2, the sprinkler 104 can include at least one frame arm 224 extending from the body 200 to an end 228 coupled with the deflector 120, and a compression screw 232 positioned at the end 228.

As depicted in FIG. 2, the activation element 124 can include a strut 236 extending between the compression screw 232 and the seal 220 to apply a force against the seal 220 (e.g., to hold the seal 220 in the outlet against fluid pressure from fluid pressure in the sprinkler 104), a hook 240 extending away from the strut 236, and a link 244 (e.g., fusible link) connecting the hook 240 with the strut 236. Responsive to a fire condition, such as a threshold temperature being met or exceeded, the link 244 can change from a first state to a second state (e.g., separate responsive to solder melting), allowing the hook 240 and strut 236 to separate, releasing the seal 220 from the outlet 208 to allow fluid to flow through the outlet 208 towards the deflector 120.

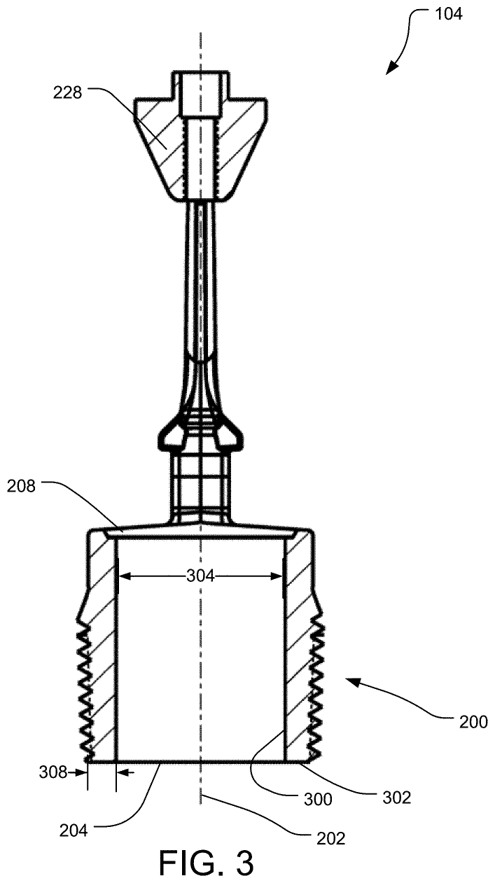

FIG. 3 depicts an example of the body 200 of the sprinkler 104. The body 200 of the sprinkler 104 can define a bore 300 extending along the longitudinal axis 202 from the inlet 204 (which can be inward from an end wall 302) to the outlet 208. The bore 300 can be shaped to facilitate a sufficient flow rate of fluid through the bore 300 and out of the outlet 208 to enable a nominal K-factor of 30.8 [gpm]/[psi]^{1/2}. The nominal K-factor can be a K-factor having a value within a threshold value of 30.8, such as within five percent or within ten percent of 30.8. For example, for a range of target pressures of fluid received by the sprinkler 104, such as from 7 psi to 175 psi, the bore 300 can be shaped so that the flow rate is sufficient for the nominal K-factor to be 30.8.

Table 1 provides examples of pressures that can be used with a plurality of the sprinklers 104 (e.g., a set of sprinklers forming a hydraulic design area in accordance with FM Global or National Fire Protection Association (NFPA) standards) to achieve flow rates compliant with FM Global and NFPA standards for various ceiling heights from 40 feet to 55 feet, including lower pressures than those used for ESFR-22 (e.g., nominal K-factor of 22.4), ESFR-25 (e.g., nominal K-factor of 25.2), or ESFR-28 (e.g., nominal K-factor of 28.0) sprinklers:

TABLE 1

| | Sprinkler | Sprinkler 104 (K-factor 30.8) | | | ESFR-28 (K-factor 28.0) | | |
|---|---|---|---|---|---|---|---|
| | Ceiling | Pressure | Flow/sprinkler | Total flow | | Flow/ | Total |
| | Height (ft) | (psi) | (gpm) | (gpm) | Pressure | sprinkler | flow |
| FM | 55 | 65 | 248 | 2234 | 80 | 250 | 2253 |
| Global | 50 | 33 | 177 | 1770 | 40 | 177 | 1770 |
| | 45 | 33 | 177 | 1770 | 40 | 177 | 1770 |
| | 40 | 27 | 160 | 1770 | 40 | 177 | 1770 |
| NFPA | 48 | 29 | 166 | 1992 | 35 | 166 | 1977 |
| | 45 | 21 | 141 | 1693 | N/A | N/A | N/A |
| | 40 | 17 | 127 | 1524 | N/A | N/A | N/A |
| | Sprinkler | ESFR-25 (K-factor 25.2) | | | ESFR 22 (K-factor 22.4) | | |
| | Ceiling | Pressure | Flow/sprinkler | Total flow | | Flow/ | Total |
| | Height (ft) | (psi) | (gpm) | (gpm) | Pressure | sprinkler | flow |
| FM | 55 | N/A | N/A | N/A | N/A | N/A | N/A |
| Global | 50 | 50 | 178 | 1780 | 63 | 178 | 1780 |
| | 45 | 50 | 178 | 1780 | 63 | 178 | 1780 |
| | 40 | 50 | 161 | 1449 | 50 | 158 | 1425 |
| NFPA | 48 | 45 | 169 | 2028 | 55 | 166 | 1992 |
| | 45 | 40 | 161 | 1932 | 40 | 142 | 1692 |
| | 40 | 25 | 126 | 1512 | 40 | 142 | 1692 |

As shown in Table 1, for several ceiling heights, the sprinkler 104 can be used to achieve standard-compliant flow rates at lower pressures than sprinklers having K-factors of 33.6 or 28.0 for ceiling heights including from 40 feet to 50 feet.

The bore 300 can define an inner diameter 304 and a wall thickness 308 from the bore 300 to the outer surface 212 of the body 200. At least one of the inner diameter 304 and the wall thickness 308 can be sized to enable the sprinkler 104 to have a nominal K-factor of 30.8. The inner diameter 304 (and the wall thickness 308) can be constant (e.g., have a value that is constant within a manufacturing tolerance), or can vary corresponding to one or more portions of the bore 300, in order to achieve fluid flow corresponding to a K-factor of 30.8.

For example, as depicted in FIG. 3, the bore 300 can be straight from the inlet 204 to the outlet 208, such that the inner diameter 304 is constant along the bore 300 from the inlet 204 to the outlet 208. For example, the inner diameter 304 (e.g., defined at the outlet 208) can be greater than or equal to 1.020 inches and less than or equal to 1.060 inches. The inner diameter 304 can be greater than or equal to 1.030 inches and less than or equal to 1.050 inches. The outlet 208 can increase in inner diameter 304 relative to the bore 300, such as to receive the 220 as described with reference to FIG. 2.

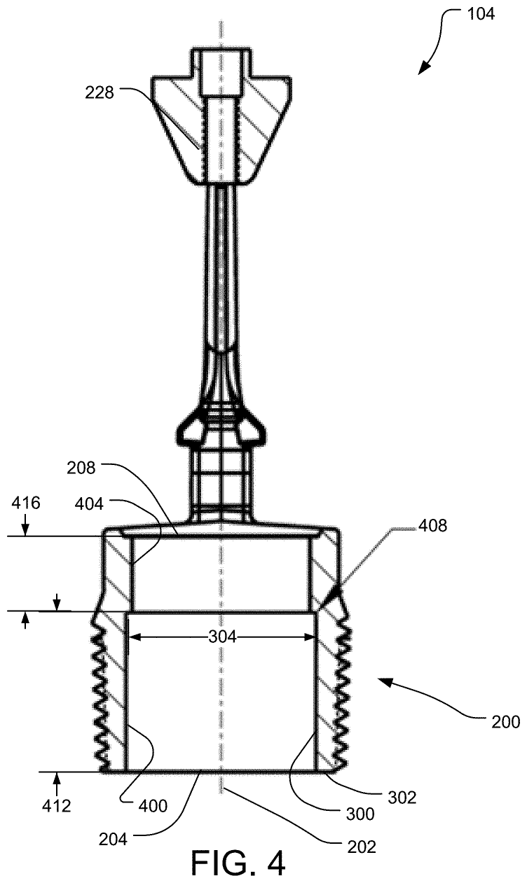

FIG. 4 depicts an example of the body 200 of the sprinkler 104, in which the bore 300 includes a first portion 400 and a second portion 404. The first portion 400 can extend from the inlet 204 to a step 408. The second portion 404 can extend from the step 408 to the outlet 208. The second portion 404 can have a lesser inner diameter 304 than the first portion 400 (e.g., a first value for the first portion 400 and a second value less than the first value for the second portion 404). The first portion 400 and the second portion 404 can be straight, such as by having inner diameters 304 that are constant.

The first portion 400 can define a first length 412, and the second portion 404 can define a second length 416. The lengths 412, 416 can be parallel with the longitudinal axis 202. The lengths 412, 416 can be sized to facilitate higher fluid flow through the bore 300, such as to reduce friction losses through the bore 300. The length 416 can be sized down to a manufacturing tolerance for forming the second portion 404, such as to enable greater flow through the relatively larger first portion 400 for a maximum extent of the bore 300 up to the outlet 208. A ratio of the first length 412 to the second length 416 can be greater than or equal to 1:1. The ratio can be greater than or equal to 10:1. The ratio can be greater than or equal to 1:1 and less than or equal to 1000:1.

The step 408 can extend radially inward, such as in a direction transverse to the longitudinal axis 202, such as perpendicular to the longitudinal axis 202. The step 408 can be positioned between an edge of the engagement member 216 and the outlet 208 relative to a direction along the longitudinal axis 202. The step 408 can extend inward to an extent such that a ratio of the inner diameter 304 of the first portion 400 to the inner diameter 304 of the second portion 404 can be greater than 1:1 and less than or equal to 1.1:1.

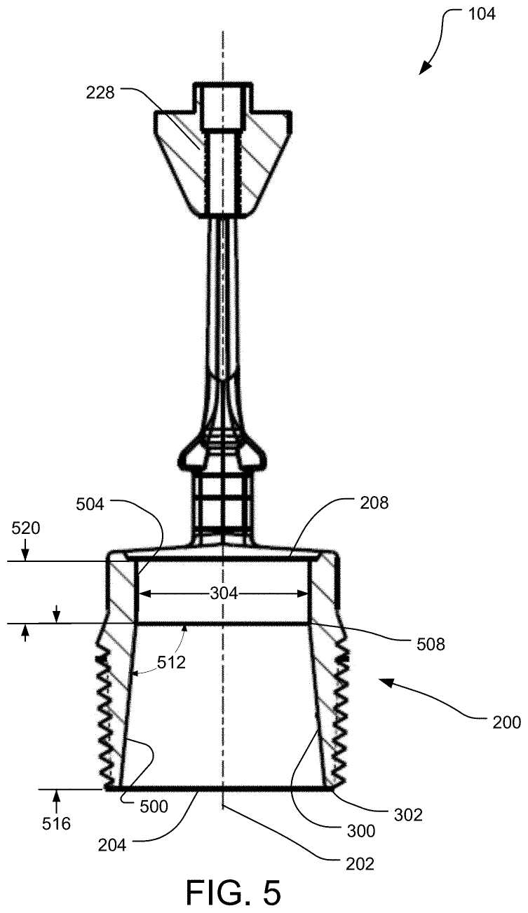

FIG. 5 depicts an example of the body 200 of the sprinkler 104 in which the bore 300 includes a first portion 500 and a second portion 504. The first portion 500 can be tapered, such that the inner diameter 304 of the first portion 500 decreases from the inlet 204 to an edge 508 between the first portion 500 and the second portion 504. The wall thickness 308 can increase as the inner diameter of the first portion 500 decreases.

The edge 508 can be a transition from the decreasing diameter (e.g., decreasing inner wall size) of the first portion 500 to the straight wall of the second portion 504. The edge 508 can be positioned further towards the outlet 208 than the engagement member 216.

The inner diameter 304 of the first portion 500 can decrease linearly (e.g., within a manufacturing tolerance of decreasing linearly). The first portion 500 can define an angle 512 at the edge 508 relative to the first portion 500 corresponding to the taper of the first portion 500. The angle 512 can be greater than 90 degrees and less than 110 degrees. The angle 512 can be greater than or equal to 90 degrees and less than 100 degrees. The angle 512 can be greater than or equal to 90 degrees and less than 95 degrees.

The first portion 500 can define a first length 516, and the second portion 504 can define a second length 520. The lengths 516, 520 can be sized to facilitate higher fluid flow through the bore 300, including to size the second portion 504 down to a manufacturing tolerance for forming the second portion 504. The first length 516 can be longer than the second length 520. A ratio of the first length 516 to the second length 520 can be greater than or equal to 2:1. The ratio can be greater than or equal to 10:1 and less than or equal to 1000:1.

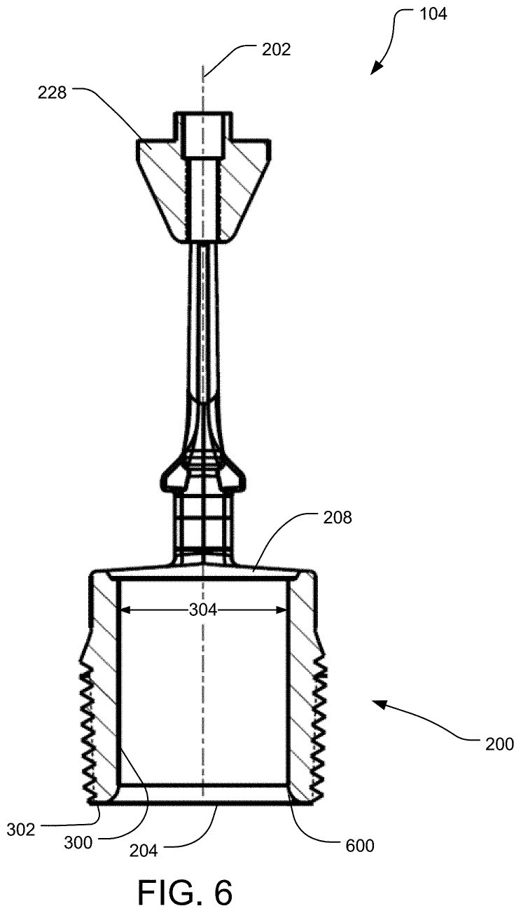

FIG. 6 depicts an example of the body 200 of the sprinkler 104 in which the inlet 204 has a radiused portion 600. For example, the radiused portion 600 can form a curve from the end wall 302 to the bore 300, which can facilitate reducing friction losses at the inlet 204. Various bores described herein with reference to FIGS. 3-6 can incorporated the radiused portion 600. The radiused portion 600 can transition from the end wall 302 (which can be perpendicular to the longitudinal axis 202) to the bore 300 (which, as depicted in FIG. 6, can be parallel with the longitudinal axis).

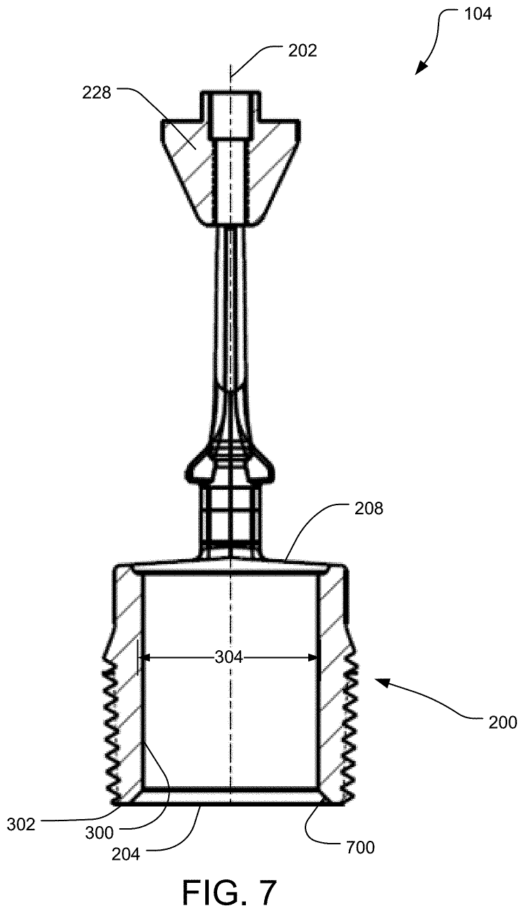

FIG. 7 depicts an example of the body 200 of the sprinkler 104 in which the inlet 204 has a chamfer 700 (e.g., chamfered portion). The chamfer 700 can form a straight transition from the end wall 302 to the bore 300, which can facilitate reducing friction losses at the inlet 204. Various bores described herein with respect to FIGS. 3-5 can incorporate the chamfered 700. The chamfer 700 can be formed at a 45 degree angle relative to the longitudinal axis 202.

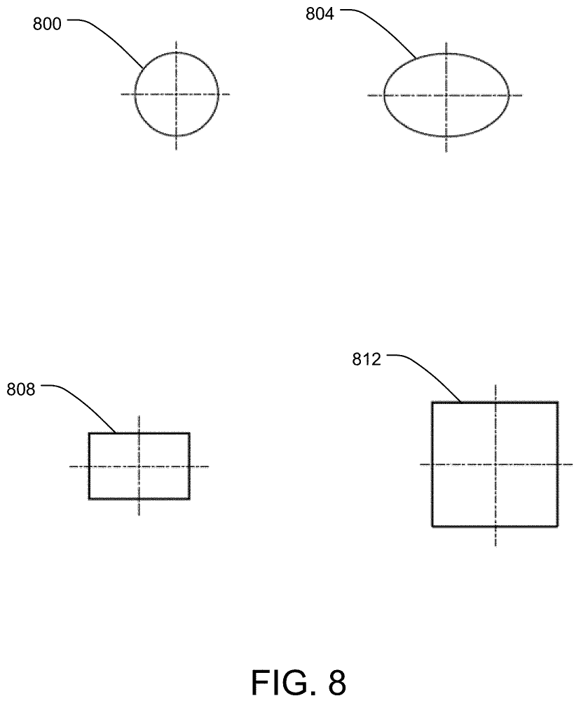

FIG. 8 depicts examples of shapes of the outlet 208. The outlet 208 can have a circular shape 800, such as a shape in which a radius of the outlet 208 is constant (e.g., within a manufacturing tolerance of constant). The outlet 208 can have an oval shape 804. The outlet 208 can have a rectangular shape 812. The outlet 208 can have a square shape 816.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the fitting assembly as shown in the various exemplary embodiments is illustrative only. Additionally, any element disclosed in one embodiment may be incorporated or utilized with any other embodiment disclosed herein.

Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A sprinkler, comprising:
a body defining a bore extending from an inlet to an outlet, at least one of an inner diameter and a wall thickness of the bore sized such that a K-factor of the sprinkler is within a threshold of 30.8, the K-factor defined in units of gallons per minute [gpm]/(pounds per square inch [psi])^{1/2}.

2. The sprinkler of claim 1, comprising:
the bore comprises a first portion extending from the inlet, a second portion extending from the first portion to the outlet, and a step between the first portion and the second portion, a ratio of an inner diameter of the first portion to an inner diameter of the second portion is greater than 1:1 and less than or equal to 1.1:1.

3. The sprinkler of claim 1, comprising:
the bore comprises a tapered portion extending from the inlet and a straight portion extending from the tapered portion towards the outlet.

4. The sprinkler of claim 1, comprising:
the bore comprises a tapered portion extending from the inlet and a straight portion extending from the tapered portion towards the outlet, a ratio of a first length of the tapered portion to a second length of the straight portion is greater than or equal to 1:1.

5. The sprinkler of claim 1, comprising:
the bore comprises a tapered portion extending from the inlet and a straight portion extending from the tapered portion towards the outlet, an angle defined by the tapered portion is greater than 90 degrees and less than or equal to 100 degrees.

6. The sprinkler of claim 1, comprising:
a thread extending along an outer surface of the bore, the thread is at least one of (1) a national pipe tapered thread (NPT) defining a nominal size of 1 inch or 1.25 inches and (2) an ISO-7-R1 thread.

7. The sprinkler of claim 1, comprising:
a seal positioned in the outlet;
at least one frame arm extending from the body;
a deflector coupled with the at least one frame arm; and
a thermal activation element between the seal and the deflector.

8. The sprinkler of claim 1, comprising:
at least one of a radiused portion at the inlet of the bore and a chamfered portion at the inlet of the bore.

9. The sprinkler of claim 1, comprising:
the outlet comprises at least one of a circular shape, an oval shape, a rectangular shape, and a square shape.

10. The sprinkler of claim 1, comprising:
the bore comprises a first portion extending from the inlet, a second portion extending from the first portion to the outlet, and a step between the first portion and the second portion, the inner diameter has a first value along the first portion and a second value less than the first value along the second portion.

11. The sprinkler of claim 1, comprising:
the bore comprises a first portion extending from the inlet, a second portion extending from the first portion to the outlet, and a step between the first portion and the second portion, a ratio of a length of the first portion to a length of the second portion is greater than or equal to 1:1.

12. A sprinkler system, comprising:
one or more pipes coupled with a fluid supply providing fluid at a pressure greater than or equal to 5 psi and less than or equal to 200 psi; and
a sprinkler comprising a bore extending from an inlet coupled with the one or more pipes to an outlet, the bore sized such that a K-factor of the sprinkler is within a threshold of 30.8, the K-factor defined in units of gallons per minute [gpm]/(pounds per square inch [psi])^{1/2}.

13. The sprinkler system of claim 12, comprising:
at least one of a 1 inch NPT fitting and an ISO-7-R1 fitting connecting the one or more pipes with the sprinkler.

14. The sprinkler system of claim 12, comprising:
the sprinkler is positioned below a ceiling of a storage commodity, the ceiling having a height greater than or equal to 40 feet and less than or equal to 50 feet.

15. The sprinkler system of claim 12, comprising:
the sprinkler is positioned below a ceiling of a storage commodity, the ceiling having a height greater than or equal to 40 feet and less than or equal to 55 feet, the sprinkler receives fluid having a pressure and outputs the fluid at a flow rate, at least one of (1) the pressure is less than or equal to 27 psi and the flow rate is greater than or equal to 160 gallons per minute, (2) the pressure is less than or equal to 33 psi and the flow rate is greater than or equal to 177 gpm, and (3) the pressure is less than or equal to 65 psi and the flow rate is greater than or equal to 248 gpm.

16. The sprinkler system of claim 12, comprising:
the sprinkler is an early suppression fast response (ESFR) sprinkler.

17. The sprinkler system of claim 12, comprising:
the bore comprises at least one of a tapered portion and a stepped portion.

18. The sprinkler system of claim 12, comprising:
the outlet comprises at least one of a radiused portion and a chamfered portion, and the outlet is at least one of circular, oval, rectangular, and square.

19. A sprinkler, comprising:
a body defining a bore extending between an inlet and an outlet, the bore shaped so that a nominal K-factor of the sprinkler is 30.8;
a seal positioned in the outlet;
at least one frame arm extending from the body;
a deflector coupled with the at least one frame arm; and
a thermal activation element between the seal and the deflector.

20. The sprinkler of claim 19, comprising:
the sprinkler receives fluid having a pressure and outputs the fluid at a flow rate, at least one of (1) the pressure is less than or equal to 27 psi and the flow rate is greater than or equal to 160 gallons per minute, (2) the pressure is less than or equal to 33 psi and the flow rate is greater than or equal to 177 gpm, and (3) the pressure is less than or equal to 65 psi and the flow rate is greater than or equal to 248 gpm.
